(19) United States
(12) Patent Application Publication
(10) Pub. No.: US 2025/0350931 A1
(43) Pub. Date: Nov. 13, 2025

(54) WiFi wireless networking method, device, and storage medium

(71) Applicant: BOWEI TECHNOLOGY COMPANY LIMITED, Jiaxing (CN)

(72) Inventors: Maoping HE, Jiaxing (CN); Lu HAN, Jiaxing (CN)

(73) Assignee: BOWEI TECHNOLOGY COMPANY LIMITED, Jiaxing (CN)

(21) Appl. No.: 19/276,886

(22) Filed: Jul. 22, 2025

Related U.S. Application Data
(63) Continuation of application No. PCT/CN2024/070172, filed on Jan. 2, 2024.

(30) Foreign Application Priority Data
Sep. 14, 2023 (CN) 202311181522.1

(51) Int. Cl. H04W 8/26; G06K 7/14; H04W 4/80; H04W 8/00

(52) U.S. Cl. CPC H04W 8/26; G06K 7/1417; H04W 4/80; H04W 8/005

(57) ABSTRACT

A WiFi wireless networking method, device, and storage medium are disclosed herein. The method includes steps of: collecting a scanned code information; acquiring a corresponding serial number according to the scanned code information; acquiring a corresponding communication address according to the serial number; acquiring all online routers; and sharing the communication address with all the online routers.

### CROSS-REFERENCE TO RELATED APPLICATIONS

This application is a continuation of International Patent Application No. PCT/CN2024/070172 filed on Jan. 2, 2024, which claims priority to Chinese patent application No. 202311181522.1, filed on Sep. 14, 2023. The disclosures of the above-referenced applications are hereby incorporated by reference in their entirety.

### BACKGROUND

In recent years, with an increased average living space per person and an increasing demand of people for wireless networks, WiFi Mesh network (wireless mesh network) apparatuses have appeared in more and more homes.

Some WiFi Mesh network apparatuses, purchased by users, are already defined as a main gateway or sub-AP (Access Point) at the factory. Some WiFi Mesh network apparatuses purchased by users are not defined at the factory, and are required to be set, by users through a management interface or mobile phone APP, as the main gateway or sub-AP, and then a networking is performed. However, the former is not flexible enough. If a purchased main gateway is damaged, a new main gateway must be purchased to perform the networking again. The latter, although flexible, has certain technical difficulties and is also rather troublesome, making it difficult for non-technical personnel to master.

### SUMMARY

A WiFi wireless networking method, device, and a storage medium are provided according to an embodiment of the disclosure. With one or more embodiments of the disclosure, the above technical problems are solved or at least partially solved.

The disclosure relates to a field of wireless networking, and in particular to a WiFi wireless networking method, device, and a storage medium.

In a first aspect of the disclosure, a WiFi wireless networking method is provided. The method includes steps of: collecting a scanned code information; acquiring a corresponding serial number according to the scanned code information; acquiring a corresponding communication address according to the serial number; acquiring all online routers; and sharing the communication address with all the online routers.

In some embodiments of the disclosure, the collecting the scanned code information includes steps of: acquiring a WiFi router; acquiring an apparatus serial number of the WiFi router; generating a corresponding QR code according to the apparatus serial number; affixing the QR code on a corresponding WiFi router; scanning the QR code to obtain a scanned code information corresponding to the QR code; and analyzing the scanned code information corresponding to the QR code.

In some embodiments of the disclosure, the collecting the scanned code information also includes a step of: decrypting the scanned code information.

In some embodiments of the disclosure, the decrypting the scanned code information includes the steps of: collecting a surface information of the scanned code information; acquiring a preset decryption database; collecting a serial number decryption information corresponding to the surface information according to the decryption database; and outputting the serial number decryption information.

In some embodiments of the disclosure, the acquiring the corresponding serial number according to the scanned code information includes steps of: acquiring a preset information serial number database; and gathering, from the information serial number database, a serial number corresponding to the scanned code information.

In some embodiments of the disclosure, the acquiring the corresponding communication address according to the serial number includes steps of: acquiring a preset address serial number database; and gathering, from the address serial number database, a communication address corresponding to the serial number.

In some embodiments of the disclosure, the acquiring all online routers includes steps of: selecting a target router; sending a first signal to the target router; acquiring a second signal fed back by the target router; and judging whether the first signal is in correspondence with the second signal; if the first signal is in correspondence with the second signal, determining that the target router is an online router; if the first signal is not in correspondence with the second signal, determining that the target router is not online.

In a second aspect of the disclosure, a WiFi wireless networking device is provided, including: an information collection module, used to collect a scanned code information; a serial number acquisition module, used to acquire a corresponding serial number according to the scanned code information; an address acquisition module, used to acquire a corresponding communication address according to the serial number; a router acquisition module, used to acquire all online routers; and an address sharing module, used to share the communication address with all the online routers.

In a third aspect of the disclosure, an electronic apparatus is provided, comprising: at least one processor; and a memory communicatively connected to the at least one processor; wherein the memory stores instructions that are executable by the at least one processor. The instructions are executed by the at least one processor, to enable the at least one processor to execute any of the aforementioned WiFi wireless networking methods.

In a fourth aspect of the disclosure, a non-transitory computer-readable storage medium is provided. The non-transitory computer-readable storage medium stores computer instructions. The computer instructions are used to enable the computer to execute any of the aforementioned WiFi wireless networking methods.

### BRIEF DESCRIPTION OF DRAWINGS

The accompanying drawings, which are incorporated in and constitute a portion of this specification, illustrate examples consistent with the disclosure and, together with the description, serve to explain the principles of the disclosure.

In order to more clearly illustrate the technical solutions in the embodiments of the disclosure or the technical solutions in the related art, the accompanying drawings required for use in the description of the embodiments or for use in the description of the technical solutions in the related art will be briefly introduced in the following. Obviously, for those skilled in the art, other accompanying drawings can be obtained based on these drawings without creative work.

FIG. 1 shows a schematic flow diagram of a WiFi wireless networking method according to some embodiments of the disclosure;

FIG. 2 shows a schematic structural diagram of the WiFi wireless networking device according to some embodiments of the disclosure;

FIG. 3 shows a schematic structural diagram of an electronic apparatus according to some embodiments of the disclosure; and

FIG. 4 shows a schematic structural diagram of a non-transitory computer-readable storage medium according to some embodiments of the disclosure.

### DETAILED DESCRIPTION

In order to make purposes, technical solutions and advantages of the embodiments of the disclosure clearer, the technical solutions in the disclosure will be clearly and completely described below in conjunction with the accompanying drawings in the embodiments of the disclosure. Obviously, the described embodiments are some embodiments of the disclosure, but not all embodiments. Based on the embodiments in the disclosure, all other embodiments obtained by those skilled in the art without any creative efforts fall within the scope of protection sought by the disclosure.

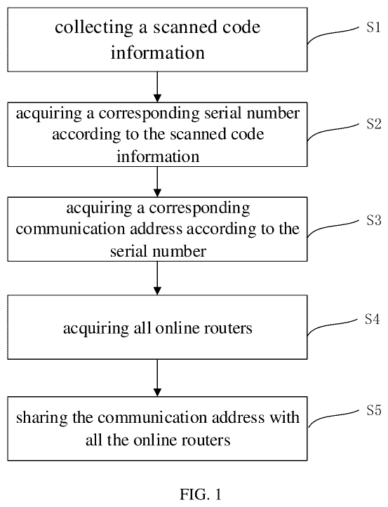

FIG. 1 shows a schematic flow diagram of a WiFi wireless networking method according to some embodiments of the disclosure. As shown in FIG. 1, a WiFi wireless networking method is provided according to an embodiment of the disclosure, which includes steps S1 to S5.

In step S1, a scanned code information is collected.

In some embodiments of the disclosure, collecting the scanned code information includes steps of: acquiring a WiFi router; acquiring an apparatus serial number of the WiFi router; generating a corresponding two-dimensional code according to the apparatus serial number; affixing the two-dimensional barcode to the WiFi router; scanning the two-dimensional barcode to obtain a scanned code information corresponding to the two-dimensional barcode; and analyzing the scanned code information corresponding to the two-dimensional barcode.

In some embodiments, a SN (Serial Number, apparatus serial number), a communication address and the like of a WiFi router need to be uniformly entered into a database, and the apparatus serial number and the communication address of the WiFi router are stored in a one-to-one correspondence in the database. The communication addresses of a router include the following MAC (Media Access Control Address) addresses for a 2.4G frequency band and a 5G frequency band: a WiFi 2.4G MAC and a WiFi 5G MAC. The database contains the above information such as the SN and communication address of all shipped WiFi routers. The database will be uniformly entered into a cloud server. When each WiFi router leaves a factory, a two-dimensional barcode may be generated from the apparatus serial number SN of the WiFi router, and the two-dimensional barcode may be affixed to a corresponding WiFi router.

In some embodiments of the disclosure, in order to improve a confidentiality of information, it may be considered to encrypt the scanned code information to increase security. At this moment, the scanned code information needs to be decrypted when an App scans a code. The collecting the scanned code information also includes a step of: decrypting the scanned code information.

In some embodiments of the disclosure, the decrypting the scanned code information includes the steps of: collecting a surface information of the scanned code information; acquiring a preset decryption database; gathering a serial number decryption information corresponding to the surface information according to the decryption database; and outputting the serial number decryption information.

In some embodiments of the disclosure, the scanned code information contains a surface information. For example, the surface information may be the two-dimensional barcode attached to a surface of a router. At the same time, a decryption database is also stored in a cloud server. The decryption database stores a serial number decryption information corresponding to the surface information. After the surface information of the scanned code information is collected, the serial number decryption information corresponding to the surface information can be directly retrieved from the decryption database.

In step S2, a corresponding serial number is acquired according to the scanned code information.

In some embodiments of the disclosure, acquiring the corresponding serial number according to the scanned code information includes: acquiring a preset information serial number database; and gathering a corresponding serial number in the information serial number database according to the scanned code information.

In some embodiments, the information serial number database is stored in the cloud server. The scanned code information and the corresponding serial number are stored in the information serial number database. After the scanned code information or the serial number decryption information is acquired and obtained, the serial number corresponding to the scanned code information or the serial number decryption information can be gathered from the information serial number database, and be output.

In step S3, a corresponding communication address is acquired according to the serial number.

In some embodiments of the disclosure, acquiring the corresponding communication address according to the serial number includes steps of: acquiring a preset address serial number database; and gathering a corresponding communication address in the address serial number database according to the serial number.

In some embodiments, the cloud server may also store an address serial number database, in which the serial numbers and corresponding communication addresses are stored. After the serial number is acquired and obtained, the communication address corresponding to the serial number can be gathered from the information serial number database, and be output.

In step S4, all online routers are acquired.

In some embodiments of the disclosure, acquiring all online routers includes steps of: selecting a target router; sending a first signal to the target router; acquiring a second signal fed back by the target router; judging whether the first signal is in correspondence with the second signal; if the first signal is in correspondence with the second signal, determining that the target router is an online router; and if the first signal is not in correspondence with the second signal, determining that the target router is not online.

In some embodiments, when it is judged whether a certain target router is online, a first signal is first sent to this router. This router, after receiving the first signal, will feedback a second signal. At this time, it is judged whether the first signal and the second signal are in correspondence; if the first signal is in correspondence with the second signal, it is determined that the target router is an online router; if the first signal is not in correspondence with the second signal, it is determined that the target router is not online.

In step S5, the communication address are shared with all the online routers.

In some embodiments, after the user buys a first WiFi router (hereinafter referred to as the first WiFi router), first, a default group is created through a mobile phone APP. Apparatuses included within this default group will form a set of Mesh network. In some implementations, a plurality of default groups may be created, and the plurality of default groups are in a one-to-one correspondence to a plurality of houses. By scanning a two-dimensional barcode on a shell of the first WiFi router through the mobile phone App, an apparatus serial number of the first WiFi router is obtained and sent to the cloud server by the mobile phone, and the apparatus serial number is added into the default group of this user. At this time, the cloud server will actively push an information of the first WiFi router to all other online routers within this group. A pushed information includes a SN, a WiFi 2.4G MAC, a WiFi 5G MAC, etc. However, since there is only one WiFi router in the group at this time, no other routers can be pushed to. A WAN (Wide Area Network) port of the first WiFi router is connected into an upstream network. The first WiFi router acquires an IP address through a DHCP (Dynamic Host Configuration Protocol) or a PPP (Point to Point Protocol), and is connected to the Internet. Next, the first WiFi router performs the following steps 1 to 3.

In step 1, a built-in client port of the first WiFi router is connected to the cloud server and sends the apparatus serial number of the first WiFi router to the cloud server. If the cloud server judges that the apparatus serial number of the first WiFi router has been added to a certain group of a certain user, an authentication is successful.

In step 2, the first WiFi router will activate a user-configured FrontHaulAP (fronthaul wireless access point) and a default BackHaul AP (backhaul wireless access point). A SSID (Service Set Identifier) of the default BackHaul AP is configured as hidden and has a preset value. An encryption way of the BackHaul AP is usually a WPA (Wi-Fi Protected Access) or a WPA2 PSK (Wi-Fi Protected Access II Pre-Shared Key). The WPA and the WPA2 PSK are two generations of Wi-Fi network security protocol. A default password also has a preset value. The BackHaul AP needs to activate a whitelist mode, and no STA (Station) is allowed to access by default.

In step 3, the built-in client of the first WiFi router synchronizes a 2.4G MAC of other routers within this group into a whitelist of the BackHaul AP through the cloud server. If other routers in the group have a 5G MAC, the 5G MAC of other routers also needs to be synchronized to the whitelist of the BackHaul AP. Since there is only the first WiFi router in the group at this time and no other routers can be pushed to, the whitelist of the BackHaul AP is empty.

When another WiFi router that a user newly purchased, (hereinafter referred to as the second WiFi router) needs to join this Mesh network, it only needs to power on the second WiFi router and scan a two-dimensional barcode on the second WiFi router through the mobile phone APP. At this time, the apparatus serial number of this second WiFi router will also be added to the default group of this user, and an information (a pushed information includes a SN, a WiFi 2.4G MAC and a WiFi 5G MAC, etc.) of the second WiFi router will be pushed to all other online routers within this group through the cloud server. The other routers that receive this information will add the 2.4G MAC and the 5G MAC to the whitelist of the BackHaul AP respectively. A BackHaul STA in the second WiFi router will periodically try to connect to a surrounding BackHaul AP (SSID is also a preset value) using the preset password. Since a MAC of the second WiFi router has been added to the whitelist of the BackHaul AP of other apparatuses within this group, the second WiFi router can be connected to the surrounding BackHaul AP. The second WiFi router will also acquire an IP from the BackHaul STA through the DHCP and start an authentication process similar to that of the first WiFi router, to complete a configuration of the FrontHaul AP and the default BackHaul AP, and synchronizes the 2.4G MAC and 5G MAC of other apparatuses within this group into the whitelist of the BackHaul AP. If other apparatuses need to join this Mesh network later, the same can be applied.

As shown in FIG. 2, a WiFi wireless networking device is provided by the disclosure, including: an information collection module 10, used to collect a scanned code information; a serial number acquisition module 20, used to acquire a corresponding serial number according to the scanned code information; an address acquisition module 30, used to acquire a corresponding communication address according to the serial number; a router acquisition module 40, used to acquire all online routers; and an address sharing module 50, used to share the communication address with all the online routers.

A WiFi wireless networking device provided by the disclosure can execute the WiFi wireless networking method provided by the above steps.

It should be understood that the above specific embodiments of the disclosure are only used to illustrate or explain the principles of the disclosure, but do not constitute a limitation of the disclosure. Therefore, any modifications, equivalent substitutions, improvements, etc., made without departing from the spirit and scope of the disclosure should be included in the protection scope of the disclosure. Furthermore, the appended claims of the disclosure are intended to cover all changes and modifications that fall within the scope and metes and bounds of the appended claims, or equivalents of such scope and metes and bounds.

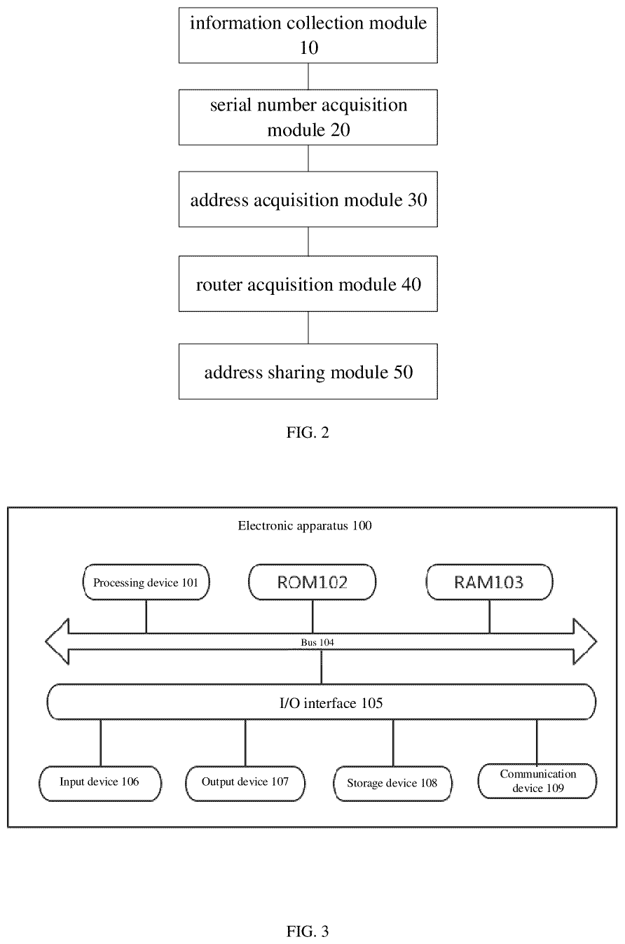

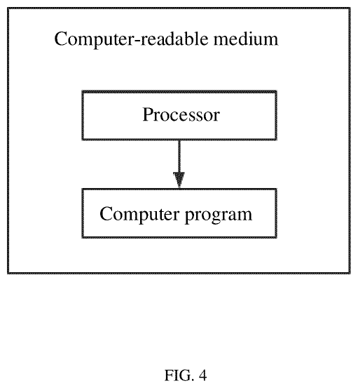

Reference is now made to FIG. 3. FIG. 3 shows a schematic structural diagram of an electronic apparatus 100 suitable for implementing an embodiment of the disclosure. The electronic apparatuses in the embodiments of the disclosure may include, but are not limited to, mobile terminals such as mobile phones, laptop computers, digital broadcast receivers, PDA (a personal digital assistants), PAD (a tablet computer), PMP (a portable multimedia player), vehicle-mounted terminal (e.g., a vehicle-mounted navigation terminal), etc., and fixed terminals such as digital TV, desktop computer, etc. The electronic apparatus shown in FIG. 3 is merely an example and should not limit functions and ranges of application of the embodiments of the disclosure.

As shown in FIG. 3, the electronic apparatus 100 may include a processing device (e.g., a central processor, a graphics processor, etc.) 101. The processing device 101 may perform various appropriate actions and processes according to a program stored in a read-only memory (ROM) 102 or a program loaded from a storage device 108 to a random access memory (RAM) 103. In the RAM 103, various programs and data necessary for an operation of the electronic apparatus 100 are also stored. The processing device 101, the ROM 102, and the RAM 103 are connected to one another via a bus 104. An input/output (I/O) interface 105 is also connected to the bus 104.

Typically, the following devices may be connected to the I/O interface 105: an input device 106 including, for example, a touch screen, a touch pad, a keyboard, a mouse, an image sensor, a microphone, an accelerometer, a gyroscope, etc.; an output device 107 including, for example, a liquid crystal display (LCD), a speaker, a vibrator, etc.; a storage device 108 including, for example, a magnetic tape, a hard disk, etc.; and a communication device 109. The communication device 109 may allow the electronic apparatus 100 to communicate with other apparatuses wirelessly or by wire to exchange data. Although the electronic apparatus 100 is shown with various devices, it should be understood that it is not required to implement or possess all of the devices shown. More or fewer devices may alternatively be implemented or provided.

In particular, according to an embodiment of the disclosure, the process described above with reference to a flow diagram may be implemented as a computer software program. For example, an embodiment of the disclosure includes a computer program product. The computer program product includes a computer program carried on a computer-readable medium. This computer program contains program codes for executing the method shown in the flow diagram. In such an embodiment, the computer program may be downloaded and installed from a network through the communication device 109, or installed from the storage device 108, or installed from the ROM 102. When the computer program is executed by the processing device 101, the above functions defined in the method of the embodiment of the disclosure are performed.

Reference is made to FIG. 4, which shows a schematic structural diagram of a computer-readable storage medium suitable for implementing an embodiment of the disclosure. The computer-readable storage medium stores a computer program. When the computer program is executed by a processor, the WiFi wireless networking method described above can be implemented.

A WiFi wireless networking method, apparatus, and a storage medium provided by the embodiments of the disclosure use a scanning way for networking. It is in line with the usage habits of users in the current society. This networking method does not need to distinguish between a main gateway or a sub-AP, and any apparatus can be used as a main gateway or a sub-AP. This networking method greatly simplifies an operational difficulty of users and is flexible.

It should be noted that, in the disclosure, relational terms such as “first” and “second” are merely used to distinguish one entity or operation from another and do not necessarily require or imply any such actual relationship or sequence between these entities or operations. Furthermore, the terms “include”, “comprise” or any other variations thereof are intended to cover a non-exclusive inclusion such that a process, method, article, or apparatus that includes a list of elements includes not only those elements, but also those not expressly listed other elements, or elements inherent to the process, method, article or apparatus. Without more constraints, an element defined by the phrase “comprising a . . . ” does not exclude the existence of other identical elements in a process, method, article or apparatus comprising the element.

The above descriptions are only specific embodiments of the disclosure, enabling those skilled in the art to understand or implement the disclosure. Various modifications to these embodiments will be readily apparent to those skilled in the art, and the generic principle defined in the disclosure may be practiced in other embodiments without departing from the spirit or scope of the disclosure. Therefore, the disclosure is not to be limited to the embodiments shown in the disclosure but is to be accorded the widest scope consistent with the principles and novel features claimed in the disclosure.

What is claimed is:

1. A WiFi wireless networking method, comprising:
collecting a scanned code information;
acquiring a corresponding serial number according to the scanned code information;
acquiring a corresponding communication address according to the serial number;
acquiring all online routers; and
sharing the communication address with all the online routers.

2. The WiFi wireless networking method according to claim 1, wherein the collecting the scanned code information comprises:
acquiring a WiFi router;
acquiring an apparatus serial number of the WiFi router;
generating a corresponding two-dimensional code according to the apparatus serial number;
affixing the two-dimensional barcode to a corresponding WiFi router;
scanning the two-dimensional barcode to obtain the scanned code information corresponding to the two-dimensional barcode; and
analyzing the scanned code information corresponding to the two-dimensional barcode.

3. The WiFi wireless networking method according to claim 2, wherein the analyzing the scanned code information corresponding to the two-dimensional barcode comprises:
decrypting the scanned code information.

4. The WiFi wireless networking method according to claim 3, wherein the decrypting the scanned code information comprises:
collecting a surface information of the scanned code information;
acquiring a preset decryption database;
gathering a serial number decryption information corresponding to the surface information according to the decryption database; and
outputting the serial number decryption information.

5. The WiFi wireless networking method according to claim 1, wherein the acquiring the corresponding serial number according to the scanned code information comprises:
acquiring a preset information serial number database; and
gathering, from the information serial number database, a serial number corresponding to the scanned code information.

6. The WiFi wireless networking method according to claim 1, wherein the acquiring the corresponding communication address according to the serial number comprises:
acquiring a preset address serial number database; and
gathering, from the address serial number database, a communication address corresponding to the serial number.

7. The WiFi wireless networking method according to claim 1, wherein the acquiring all online routers comprises:
selecting a target router;
sending a first signal to the target router;
acquiring a second signal fed back by the target router; and
judging whether the first signal is in correspondence with the second signal; if the first signal is in correspondence with the second signal, determining that the target router is an online router; if the first signal is not in correspondence with the second signal, determining that the target router is not online.

8. A WiFi wireless networking device, comprising:
an information collection module, used to collect a scanned code information;
a serial number acquisition module, used to acquire a corresponding serial number according to the scanned code information;
an address acquisition module, used to acquire a corresponding communication address according to the serial number;
a router acquisition module, used to acquire all online routers; and
an address sharing module, used to share the communication address with all the online routers.

9. An electronic apparatus, comprising:
at least one processor; and,
a memory communicatively connected to the at least one processor; wherein,
the memory stores instructions executable by the at least one processor, and wherein the instructions, when executed by the at least one processor, enable the at least one processor to perform the WiFi wireless networking method according to claim 1.

10. A non-transitory computer-readable storage medium, comprising computer instructions stored thereon, wherein the computer instructions are used to enable the computer to execute the WiFi wireless networking method according to claim 1.
